(19) United States
(12) Patent Application Publication
(10) Pub. No.: US 2004/0055475 A1
(43) Pub. Date: Mar. 25, 2004

(54) Disposable support for charging bakery lumps or others to be baked and its fabrication process

(76) Inventor: Erick Canicas, Bordeaux (FR)

Correspondence Address: HORST M. KASPER, 13 FOREST DRIVE, WARREN, NY, 07059, US

(21) Appl. No.: 10/247,130

(22) Filed: Sep. 19, 2002

(51) Int. Cl. A23L 1/00

(52) U.S. Cl. 99/353

(57) ABSTRACT

The invention concerns plates in the form of superposed gutters and retained in a metallic frame, intended to receive the lumps of a bakery with the purpose of charging the lumps, wherein the said plates have to be cleaned periodically for eliminating the calcined slags which pollute the plates, the cleaning which requires a specialized material, which renders the operation burdensome. The invention allows to eliminate the costs of this cleaning by the generation of plates which play the same role in the bakery operations but which are low-cost by being produced with a new economic material and by way of a production process which is low-cost, which are requiring only little manual labor, which can be disposed of and be replaced by new plates having a lower-cost as compared to the cost of cleaning. The plates which are the object of the invention, can comprise superposed gutters in one single and the same piece, or they can include gutters (8) superposed in the frame (9), but being individual gutters, which allows to dispose of and to replace only that gutter or only those gutters which need to be replaced.

In fact, always the lumps are placed on plates present in a sequence of longitudinal honeycomb cells in the form of waves or gutters disposed parallel between themselves and retained, superposed on metallic frames which metallic frames assure the stiffness of the assembly for the baking of the bread in industrial bakeries and very frequently in small-scale bakeries. These plates, which are generally made of a perforated metallic material and sometimes out of a woven lattice are called “sheets of panification” or, more generally, “bread sheets”. The said sheets are always contained in metallic frames and are covered by an anti-adhesive food product which is resisting to the oven temperature such as silicone.

There are therefore these frames equipped this way, which frames receive the lumps which are placed for their baking. Their number depends on the volume of production of said bakery, which can say that it is not rare in an industrial bakery that there are several thousand, taking count of the sheets in-service and those sheets in inventory.

Since despite the presence of the anti-sticking product, the paste begins to adhere partially to the plate whatever the nature of the plate might be. And the small quantity which will remain adhering to the sheet after each baking, after several cycles, begins to char and carbonize, forming a slag, which slag has to be eliminated periodically by a major cleaning process rendering the material bare, followed by a new coating of silicone.

This operation, which requires an important specialized material, is effected by specially equipped enterprises to which the sheets to be cleaned are transported.

Considering the substantial number of sheets, that can be used in a single bakery, this operation is burdensome, so much by the periodic costs of transport of the bread sheets to the cleaning enterprise, by the obligation to have a quantity of bread sheets in inventory necessary for assuring the continuity of the work of the bakery during the period of absence of the lot of sheets sent for cleaning (sometimes several days).

In order to suppress in these costs of transport and to suppress the heavy investment in the additional stock, there have been created mobile cleaning units which are applied at the clients, for treating the bread sheets by effecting an operation, the sheets being delivered to the cleaning from their discharge, and their cleaning is effected during the times of the following batches. This is made possible, thanks to the quickness of operation effected by these mobile shops, which allow automatically, continuously to effect a cycle of cleaning during the time of one batch.

Thanks to these mobile shops, objects of the French patents number 92-06168 and number 94-02495, the transport costs to the treatment enterprise are eliminated and the stock can be reduced to the quantity of sheets alone necessary for a continuous baking operation without fear of interrupting the baking operation, and wherein each sheet is immobilized only for very short times of its own cleaning.

Despite the advantages obviously associated with these mobile shops, it remains possible to further reduce the costs by suppressing the operation of the cleaning itself. This is the goal of the present invention.

According to the present invention effectively the charging support of the lumps is called or designated preferably “charging plate”, when it begins to be charged with a slag, at the point of being useless in its state, is not any longer sent to cleaning, but it is squarely disposed of. This is made possible by the nature of the new support, where the commercial value of the new support is reduced to a point which is lower than the cleaning cost, thanks to a new material used for its fabrication as well as thanks to a new concept of the kind of association of semi-cylindrical honeycombs (also well designated under the name: “waves” or “gutters”) for the former so-called “charging plate”.

According to the present invention effectively each charging plate is not any longer composed of a plate of metallic grills or of a textile lattice, but is fabricated by means of a paste of cellulose extruded according to an adequate form, or molded, or laminated in the sheets of a convenient thickness, then is punched under a convenient form. The waves or gutters obtained this way by molding can form a homogeneous assembly of parallel disposed gutters, wherein the set assembly is rendered stiff by one or by several reinforcements forming a frame of the same dimensions which has the standard bread sheet. The said gutters, preferably obtained by extrusion, form individual gutters, associated and retained in a number equal to that number of gutters formed in a metallic frame of standard dimension. In this way, in the two cases, there is presented the same appearance and the same advantages for the baking of bread as are furnished by conventional bread sheets.

And the cost price of such a mode of fabrication, as well as by the material cost itself and by its easiness of processing, is inferior to the cost of the simple cleaning, even if it is effected on the place of its utilization by a movable shop, rendering it more economic to dispose with the cleaning.

The invention is also characterized by various details which result from the description which follows, at the support of which:

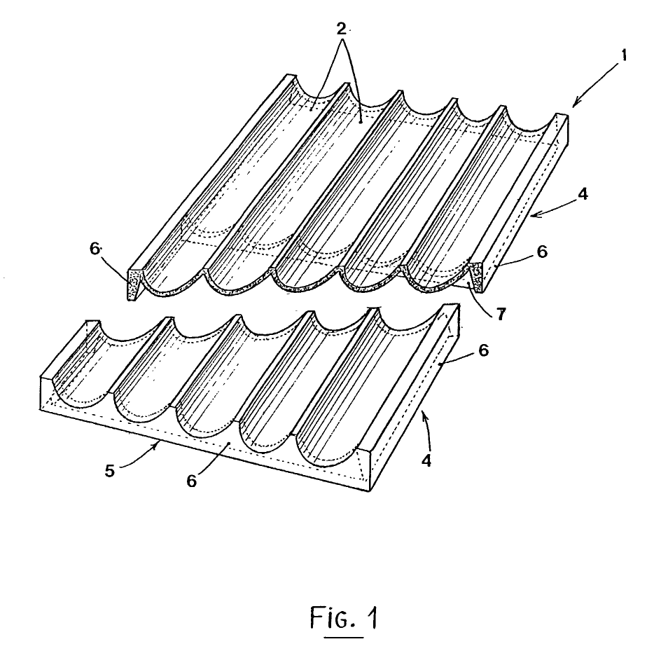

FIG. 1 is a schematic, isometric perspective, broken view of a charging plate of lumps according to the present invention and comprising the waves or gutters which are to receive the lumps, associated by fabrication for forming a single piece;

FIG. 2 is a schematic, isometric perspective, partial view of an assembly of waves or gutters according to the present invention, individually fabricated, then superposed on one frame for forming together a charging plate itself of lumps, which waves or gutters are there installed;

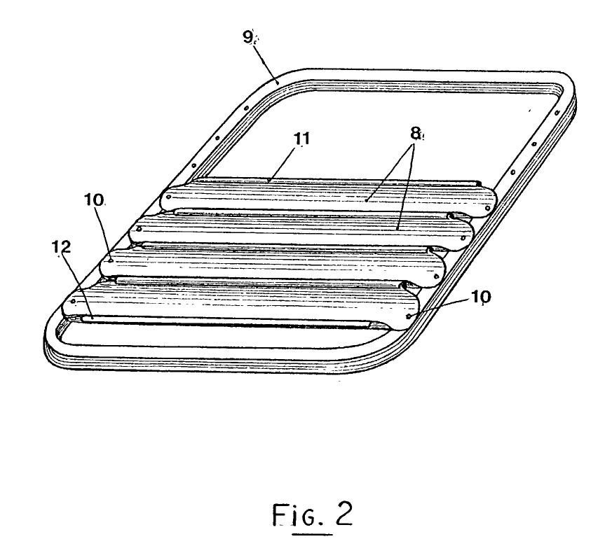

FIG. 3 is a schematic, isometric perspective, broken view of a wave or gutter, individually fabricated and capable of being associated to the like gutters for forming together a charging plate;

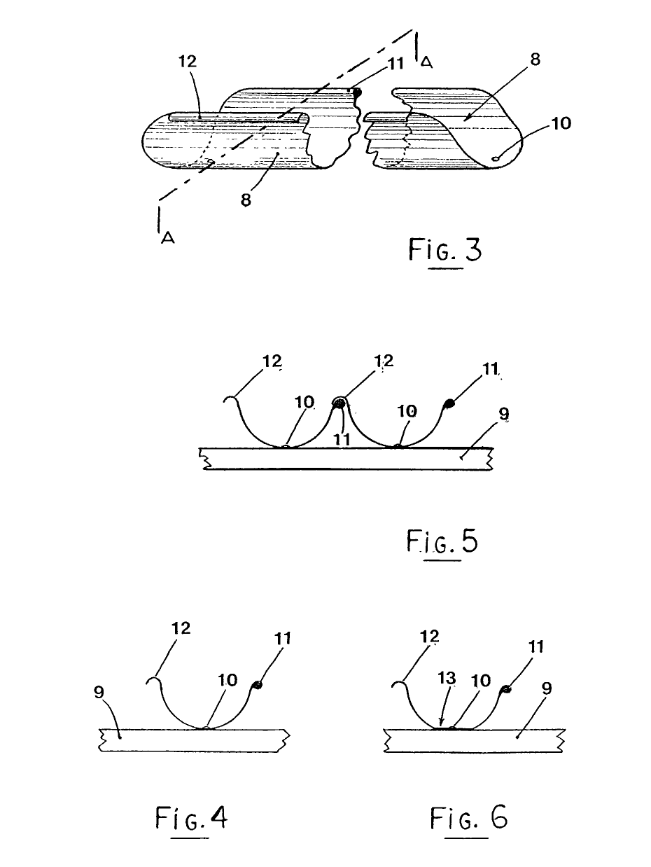

FIG. 4 is a schematic, transverse sectional, elevational view of a wave or gutter along section line AA of FIG. 3:

FIG. 5 is a schematic view, according to the same transverse section, of two waves or gutters, showing their mode of assembly in a lateral superposition;

FIG. 6 is a schematic view along the same transfer section in elevation of a wave or gutter showing a variation with a perspective of increasing the stability.

The charging plate 1 furnished for receiving the lumps is formed by a sequence of gutters 2 identical among themselves, wherein the gutters 2 are superposed for forming together one same charging plate 1 comprising a rib 6 forming the stiff frame of the system on each of the two sides 4 of the charging pate 1 and at each of the ends 5 of the charging plate 1.

In addition, one or several ribs 7 disposed parallel to the ends 5 can be installed on the said plate with a perspective of completing the stiffness, if necessary, for resisting the weights of the lumps.

The said plate is a thus formed and is fabricated by means of an economic, light material rendered stiff by its treatment and furnishing a food character, and resisting to the most elevated temperatures occuring in a bakery without damage or deformation, wherein said material is a paste made of cellulose ground and mixed material in the presence of a binder resisting to the baking temperature of the bread (240 degrees centigrade), such as an amino-plastic resin, a carbamide resin, an amino aldehyde resin, a urea resin and of an anti-adhesive product such as silicone suspended in cyclohexane and loaded with iron oxide with the purpose of increasing its resistance to temperature, which this way can attain 300 degrees centigrade continuously, wherein the totality of these operations are made under nitrogen N in order to avoid a premature polymerization of the silicone. The said paste is then passed to the core oven, then compressed, molded or stamped, and baked during a thermo forming operation at the highest temperature, which can be obtained during panification.

The product obtained in this manner in the form of a gutter is recognized as a food product, as anti-adhesive, and as resisting to the said baking temperature of the bread without damage or deformation.

According to the nature of the material employed such as described and the fabrication mode of said plate which requires only little manual labor, its cost price can be overall lower to the cost of simple cleaning, even if the cleaning is effected within the enterprise utilizing a mobile shop.

It will also be advantageous, when the said plate presents many slags attached and carbonized to dispose of the plate for replacing the plate also by a new plate instead of proceeding with the cleaning of the plate.

According to a variation the presented by the FIGS. 2 through 6, the waves or gutters obtained by a unique operation of casting for forming a homogeneous and stiff plate, as it is to be considered, can also be individually fabricated with the aid of the same material which supports the same impregnation or coating of an anti-adhesive product. The waves or gutters can be obtained by molding, by punching, or by extrusion.

After the individual fabrication of the waves or gutters, these are superposed parallel amongst themselves in such a way that the gutters 8 (FIG. 2), are individually fixed on a metallic frame 9 (of standard dimensions) at the level of each of their ends by means of clips 10 known for being put in place by simple manual pressing and easily manually lifted with the aid of a simple punch as a unique tool.

The metallic frame 9 will support this way also the gutters 8, which are contained in a classic frame of the same dimensions.

In order to assure the rigidity of their assembly, according to FIG. 5 each gutter 8 is bordered longitudinally along one of its sides, by a stiffening rod 11 made out of the same material and having a diameter sufficient for being stiff, and on the other side by an turned down edge 12 in the form of an arched handle (FIG. 4) capable of mounting perfectly the rod 11 of the gutter immediately neighboring, which assures the sufficient stiffness of their connection (FIG. 5).

In the same way and in order to assure a larger stability each of the gutters presents a flat bottom 13 according to FIG. 6 in the transverse work plane of the superposed totality of individual gutters 8.

The device being in this manner constituted, in the form of a plate (FIG. 1), one concedes that it will be more advantageous to dispose of the plate when the plate is found in a state incapable of being cleaned instead of proceeding with its cleaning and even if the cleaning would be executed by means of a mobile shop and that the real advantages which in the past such a shop generated on the plan of the reduction of investments by reduction of the inventory necessary for assuring a continuous operation, while a lot of classic bread sheets will be send to the cleaning at the enterprises foreign to the bakery.

And this new advantage of by the possibility of replacing cleanly and simply a used plate by a new plate and a lower-cost to the cost of the cleaning of the plate is further achieved by the usage of the individual disposable gutters 8 (FIGS. 2 to 6).

It is eventually effectively possible in this case to replace only the gutter which appears to be prematurely soiled or deteriorated whatever the cause of this might be on one and the same frame 9 and this operation of replacement by individual units is facilitated by the use of clips which do not require any particular tool.

The use of gutters 8 presents also an additional advantage at the level of the inventory, not only with respect to the number of objects but also with respect to the volume of spatial requirements thanks to the possibility of stacking a large number of new gutters in a limited volume in the absence of the frames, which frames remain re-useable.

For the possibility of disposal of used elements, being the complete plates 1 or the individual gutters 8 and for replacing them by identical new elements, this completely eliminates the cost of cleaning, whatever method will be used for cleaning.

This economy is achieved as it has been seen by the important reduction of the investments in the rotating inventory intended to assure the continuous rotation of the operations of the bread baking, in the same way as by the releasing of space for storing of this additional inventory.

According to FIG. 3 each end of the individual gutters have their upper edges rounded off in order to avoid all ill-timed catching during their manipulation.

Whatever be the form of the individual gutters 8 (FIG. 2) of or under the form of grouped in one and the same plate 1 (FIG. 1), for meeting the technical requirements as well as the hygienique requirements, the security and economic requirements, the individual or associated disposable gutter, which forms the basis of the present invention, is made of a material of low-cost, light weight, rendered stiff by its treatment, presenting a food character, continuously resisting to temperatures which are the highest atttained in a bakery without damage or modification of shape or structure, auto-degradable without production of harmful or noxious side products, without releasing any inflammable gas or toxic vapor or bad smells, whatever be the course of the baking of the lump, which the gutter supports, or in the course of the eventual distraction of said material by incineration or in case of an accidental fire.

The material which presents these qualities is a paste made of ground and mixed cellulose materials in the presence of a binder resisting to the highest attained temperatures in the bakery (higher than 240 degrees centigrade), such as an amino plastic resin, a carbamide resin, amino aldehyde resin, urea resin, and often anti-adhesive product such as the silicone suspended in cyclohexane and loaded with iron oxide with a perspective of increasing its temperature resistance, which temperature resistance can attain 300 degrees centigrade continuously, wherein the totality of these operations are made under N in order to avoid a premature polymerization of the silicone. The said paste is then compressed, molded, punched, or formed in the course of an operation of thermal forming, and the temperature which is the most highest which can be attained during panification, then passed to the core oven at the necessary temperature (200 degrees centigrade approximately) and the necessary time (approximately 20 minutes) for assuring the complete evaporation of the cyclohexane.

The product obtained in this manner in the shape of an individual gutter or the like is recognized to be a food product, anti-adhesive, and resistant to said temperature of the bread baking without damage or deformation.

Taking into account the nature of the material employed such as described and of its mode of fabrication which requires only little manual labor, the cost price of the charging support of the lumps obtained in this manner can be overall less than the cost of a simple cleaning of the bread sheets actually applied, even when the said cleaning is effected within the utilizing enterprise by a mobile shop.

The production can also be obtained by stamping or punching of a multilayer sheet of cardboard, wherein the interposed adhesive is thermoplastic and hardening under pressure for assuring the stiffness of the total unit and for avoiding any deformation in the course of the travel in the furnace, wherein the obtained product is coated with silicone loaded with iron oxide.

The wave made in this manner in the form of a gutter (grouped in the form of a plate or individually) can have a smooth or a perforated surface. The wave can also present an inner surface carrying different projections of the kind to reduce the contact points with the lump.

These projections can advantageously present the form of longitudinal parallel undulations or of a rolling nature, of low height, wherein this arrangement allows a quick removal of the most important slags by a simple superficial longitudinal brushing, which brushing can be easily automatically and locally effected, at the exit of the oven, after each removal of the baked bread.

Additionally it is interesting to note that this mode of production of disposable charging supports for the lumps of the bakery can also be applied without modification of the concept or of the mode of application to variations which form the baking trays of the pastry products, in particular: the plates of the pastries or all the other accessories such as the molds of all possible forms used in connection with this activity.

In case the slags of the lumps remain attached despite everything after several baking cycles of the product, which product the slags are supporting, then it is sufficient to release that or those of the gutters from the frame, which frame supports that or those gutters, which gutters show the requirement to replace that or these gutters by one or several new gutters, wherein the new gutters are rapidly attached to the frame by means of an adequate clip 10.

The stiffness of the assembly of the units of these gutters placed parallel amongst themselves and fixed onto the frame 9 is obtained by the complimentary structure of the upper edges of each one of the gutters, wherein the arched handle 12 of one of the upper edges mounts perfectly to the rod 11 of the other upper edge. The manipulation of the frame, which is equipped in this manner, is performed in the same kind as it is done for the existing frames furnished with a plate of homogeneous waves.

The gutters removed and retired after their usage are thrown out and are disposed of in view of being incinerated.

Another advantage, and not the least advantage, is furnished by the considerable economy of investment necessary for the inventory of a quantity of classic bread sheets, which quantity is at least equal to the quantity of those classic bread sheets which are periodically sent to cleaning, in order to allow continuous operations of panification during the necessary times for the return of the cleaned bread sheets (sometimes several days).

Therefore thanks to the object of the present invention it suffices to have an inventory of gutters or of plates which is sufficient for assuring the replacement of the soiled gutters or of the soiled frames, which only necessitates a very small investment in a relative scale.

In the case of the use of individual gutters, the covering of the necessary inventory will in addition be weaker as there will be no inventory of the frames themselves. In addition, moreover the individual waves or gutters can be stored nested one in the other, which cannot be realized with the actually equipped frames such as they are known.

Therefore one concludes that whatever be the mode of production of the individual gutters or of the disposable plates, their application by replacing waved plates made of metal or of textiles as conventionally used allows to realize a considerable economics by elimination of the cleaning costs as well as by a reduction of the nonproductive investment necessary for the inventory of the quantity of bread sheets, which quantity was indispensable for assuring continuous operations of panification during the times of cleaning the bread sheets soiled during the course of their usage. The release of a real estate surface contributes also to assuring the sought after economics, where the real estate surface is lesser for the inventory of the new device.

1. Disposable support for the charging of lumps of a bakery or of others in view of baking characterized in that the waves receiving the lumps, be the waves in the form of individual gutters (8) or associated in the form of a plate (1), are made out of a material of little burden, light weight, rendered stiff by its treatment, having a food character, capable of continuously resisting to the highest temperatures attained in a bakery without modification of form or structure, auto-degradable without a production of toxic by-products, not releasing any flammable gas or any toxic vaporous or bad smells, whatever be the course of the baking of the lumps which the gutters support, or during the course of the eventual destruction of said material by incineration or in case of an accidental fire.

2. Disposable support for the charging of lumps in a bakery or of others in view of baking, according to claim 1, characterized in that said material is a paste made out of crushed and kneaded cellulose material in the presence of a binder which is resistant to the highest temperatures obtained in a bakery, such as an amino-plastic resin and of an anti-adhesive product, such as the silicone in suspension in cyclohexane and loaded with iron oxide, wherein these operations overall are performed under nitrogen N2, wherein the said paste is then compressed, molded, punched, or formed in the course of operation of thermal forming, at the highest temperature which can be attained during panification, then passed to a core furnace at the temperature and at the time necessary for assuring the total evaporation of the cyclohexane.

3. Disposable support for the charging of lumps in a bakery or of others in view of baking, according to claim 1, characterized in that the said material is a punched sheet of a multilayer cardboard, wherein the interposed thermally hardenable adhesive hardens under pressure for assuring the stiffness of the unit and for avoiding any deformation in the course of their stay in the oven, wherein the obtained product is coated with silicone loaded with iron oxide.

4. Disposable support for the charging of lumps in a bakery or of others in view of baking, according to any one of the claims 2 or 3 characterized in that the material treated in this manner forms a sequence of gutters (2) of identical shape amongst themselves and assembled in a superposed fashion for forming together a single charging plate (1) carrying a rib (6) forming a rigid frame of the system on each of its two lateral sides (4) and at each of its ends (5).

5. Disposable support for the charging of lumps in a bakery or of others in view of baking, according to claim 4, characterized in that one or several ribs (7) disposed parallel to the ends (5) are installed under said plate with respect to completing the stiffness if necessary.

6. Disposable support for the charging of lumps in a bakery or of others in view of baking, according to one of the claims 2 or 3, characterized in that the waves or gutters (8) are individually fabricated and superposed parallel to each other, fixed onto a metallic frame (9) by means of a clip (10) at the level of each of their ends.

7. Disposable support for the charging of lumps in a bakery or of others in view of baking according to claim 6, characterized in that each individual gutter is longitudinally bordered on one of its sides by a stretcher rod (11) made out of the same material and offered diameter sufficient for being stiff, and on the other side by a turned down edge (12) in the form of a rounded handle and capable of perfectly mounting the rod (11) of the wave immediately neighboring in order to assure a sufficient strength of their connection.

8. Disposable support for the charging of lumps in a bakery or of others in view of baking according to claim 7, characterized in that in the transversal plane of the assembly of superposed individual gutters (8), each of the individual gutters presents a flat bottom (13) for assuring a highest stability.

9. Disposable support for the charging of lumps in a bakery or of others in view of baking according to claim 8, characterized in that the end of each of the longitudinal edges of said gutters associated in one same plate (1) or individual gutters (8) are rounded.

10. Disposable support for the charging of lumps in a bakery or of others in view of baking according to one of the preceding claims, characterized in that the inner surface of the gutters can exhibit projections of different forms such as longitudinal parallel waves of a small height and allowing to reduce the contact surface of the lumps.
